(19) United States
(12) Patent Application Publication
(10) Pub. No.: US 2014/0043484 A1
(43) Pub. Date: Feb. 13, 2014

(54) METHOD FOR MANUFACTURING AN OPTICAL DEVICE AND OPTICAL DEVICE

(71) Applicants: Ulrich Seger, Leonberg-Warmbronn (DE); Stefan Keith, Renningen (DE)

(72) Inventors: Ulrich Seger, Leonberg-Warmbronn (DE); Stefan Keith, Renningen (DE)

(21) Appl. No.: 14/000,274

(22) PCT Filed: Dec. 28, 2011
(86) PCT No.: PCT/EP11/74160

§ 371 Date: Oct. 28, 2013

(30) Foreign Application Priority Data
Feb. 17, 2011 (DE) 10 2011 004 284.9

(51) Int. Cl. B29D 11/00; H04N 5/225

(52) U.S. Cl. CPC B29D 11/00; H04N 5/2254
USPC 348/148; 348/335; 348/340; 264/1.7

(57) ABSTRACT

A method for manufacturing an optical device including manufacturing a first element from a first component, manufacturing at least one second element from a second component, the first and second elements being manufactured with the aid of a two-component injection molding process and at least the first element being designed as an optical element. An optical device, a corresponding image sensor and a corresponding use are also described.

### FIELD

The present invention relates to a method for manufacturing an optical device, an image sensor that has an optical device and a corresponding use.

### BACKGROUND INFORMATION

Optical devices or devices for processing visual signals are used, for example, in the video field, in particular in conjunction with video cameras. Such optical devices may, for example, include glass lenses for projecting an image onto a film of the video camera. However, such glass lenses require very precise calibration as well as extremely precise manufacturing, of both the glass lens itself as well as its mount, in order to avoid image defects.

German Patent Application Nos. DE 199 47 767 B4 and DE 199 32 700 C1 describe manufacturing plastic objects using multi-component injection molding.

### SUMMARY

In accordance with the present invention, a method for manufacturing an optical unit is provided including manufacturing a first element from a first component, manufacturing at least one second element from a second component, the first and second elements being manufactured with the aid of a two-component injection-molding process, and at least the first element being designed as an optical element.

In accordance with one example embodiment, the optical device which is manufactured, includes a first element composed of at least one first component, a second element composed of at least one second component, as well as a support, at least one of the two elements being situated on the support and at least the first element being designed as an optical element, and the first and second components being a plastic material.

An example image sensor having an optical device, and a light-sensitive chip, and a use of an optical device in a motor vehicle are also provided.

An example method in accordance with the present invention for manufacturing an optical device, and an example optical device may have the advantage that it is accordingly possible to manufacture an optical device extremely cost-efficiently and at the same time achieve a desired precision in the arrangement of the two elements. Moreover, an extremely compact design of the optical device is possible.

It is also possible to manufacture in this way not just two, but three or a plurality of elements with the aid of a multi-component injection molding process, two of these elements being designed as optical elements.

According to one advantageous refinement of the present invention, the first and the second elements are manufactured from different components. The advantage achieved thereby is that it increases the flexibility during manufacturing since different materials may be used for different requirements for the optical device. In addition, components may be used that are more cost-efficient.

According to another advantageous refinement of the present invention, at least one of the two elements is sprayed onto a support of the optical device. This has the advantage of allowing for easy and cost-efficient fixation of the at least one element.

According to another advantageous refinement of the present invention, the second element is designed as a mount for the optical element. The advantage achieved thereby is that both the mount and the optical element may be manufactured in a cost-efficient and time-saving manner with the aid of the two-component injection molding process.

According to another advantageous refinement of the optical device, the second element is designed as a mount for the first element. The advantage achieved thereby is that both the mount and the optical element may be manufactured in a cost-efficient and time-saving manner with the aid of the two-component injection molding process.

According to another advantageous refinement of the present invention, the second element is designed as an optical element, in particular as a light conductor. The advantage achieved thereby is that different applications may be used, for example on an image sensor on a support. If the second element is designed, in particular as a light conductor, an additional option for transmitting optical information may be provided.

According to another advantageous refinement of the present invention, the first element is designed in particular as an aspherical lens and/or a diffractive optical element. The advantage achieved thereby is that it provides an optical device that is simple to manufacture.

### BRIEF DESCRIPTION OF THE DRAWINGS

Exemplary embodiments of the present invention are shown in the figures and described in greater detail below.

FIG. 1 shows a cross section of an optical device according to a first specific embodiment of the present invention.

FIG. 2a shows a second specific embodiment of the present invention.

FIG. 2b shows a top view of a light-sensitive chip of the optical device according to FIG. 2a.

### DETAILED DESCRIPTION OF EXAMPLE EMBODIMENTS

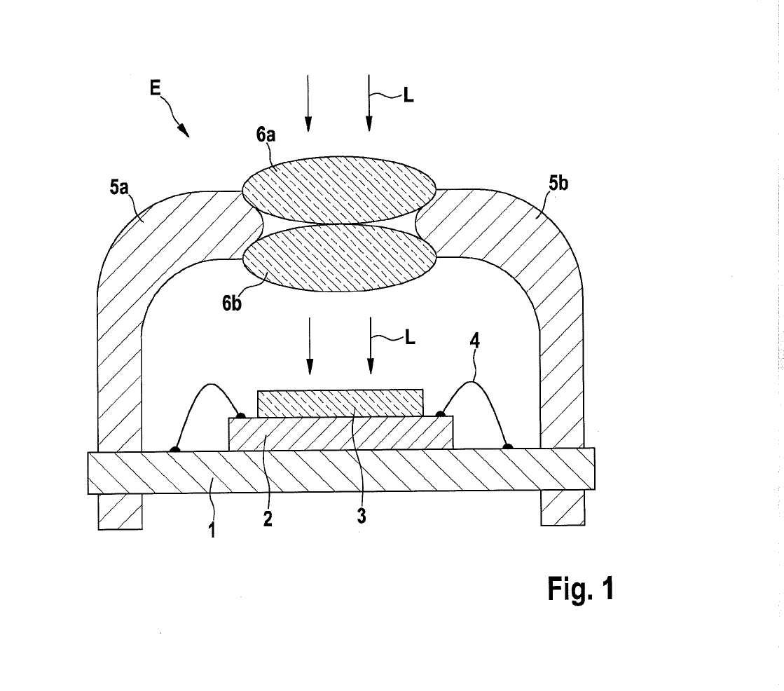

FIG. 1 shows a cross section of an optical device according to a first specific embodiment of the present invention.

FIG. 1 shows a schematic representation in a side view of an optical device E in the form of an image sensor. The image sensor includes a support 1 on which a light-sensitive chip 2 is centrally situated. Light-sensitive chip 2 is attached with the aid of bonding wires 4 to support 1, for example, a circuit board for establishing electrical contact. Situated on the upper side of light-sensitive chip 2 is a glass-like cover 3 for protecting light-sensitive chip 2. The former is appropriately transparent in design in order to allow the passage of light L. Formed on both the left and right side on support 1 is a second element 5a, 5b, which extends outward from support 1 in a generally semicircular manner and encloses light-sensitive chip 2 and glass cover 3. Situated generally perpendicularly above light-sensitive chip 2 and glass cover 3 are two lens elements 6a, 6b, one above the other, which are fixed laterally in position by second element 5a, 5b. Light L is able to pass from above through lens elements 6a, 6b and via glass cover 3 and may strike light-sensitive chip 2 and is detected by the latter.

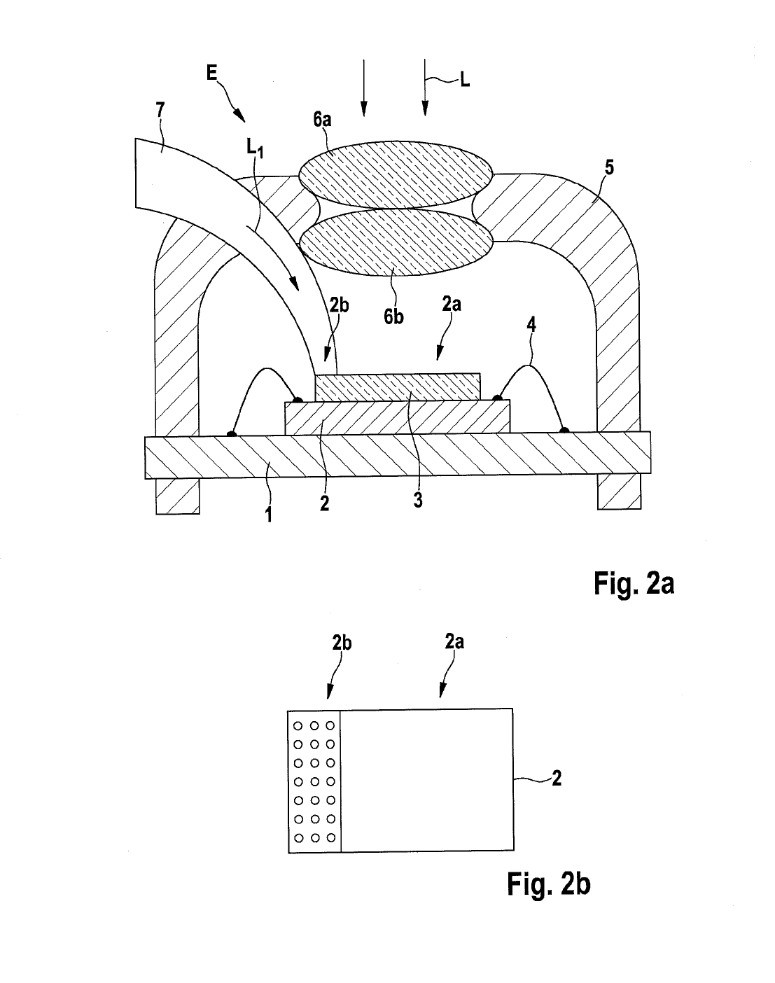

FIG. 2a shows a cross section of a second specific embodiment of the present invention.

The design of optical device E shown in FIG. 2a is essentially identical to that shown in FIG. 1. Unlike FIG. 1, a light conductor 7 is situated in the left area of mount 5 with which additional light L₁ may be guided to the surface of light-sensitive chip 2. In this design, light conductor 7 is fixed to support 1 at least partially via the left mount, i.e., element 5a, thereby allowing light L₁ to be reliably guided by light conductor 7 to the surface of light-sensitive chip 2.

In this design, light conductor 7 is also generally curved or semicircular so that it contacts the surface of glass cover 3 of light-sensitive chip 2 and extends generally in parallel to support 1 outside of mount 5a.

FIG. 2b shows a top view of a light-sensitive chip of the optical device according to FIG. 2a.

The top view of light-sensitive chip 2 is shown in FIG. 2b. Here, light-sensitive chip 2 has two different areas 2a, 2b. First area 2a may be acted upon by light through lens elements 6a, 6b, whereas second area 2b may be acted upon by light L₁ from the light conductor. This makes it possible to couple light L₁ from light conductor 7 into a selected area of light-sensitive chip 2. Light conductor 7 is also manufactured from the same material and the same component as lens elements 6a, 6b. The two differing areas 2a, 2b on light-sensitive chip 2 make it possible to implement different applications, for example, rain sensors with the aid of light L and a driver assistance system, for example, an automatic daytime running light via light conductor 7 with the aid of light L₁.

In summary, an advantage of the present invention is that the optical device may be extremely cost-efficient and may require minimal installation space.

Although the present invention is described above with reference to preferred exemplary embodiments, it is not limited thereto, but may instead be modified in a number of ways.

1-10. (canceled)

11. A method for manufacturing an optical device, comprising:
manufacturing a first element from a first component; and
manufacturing at least one second element from a second component;
wherein the first and the second elements are manufactured with the aid of a two-component injection-molding process, and at least the second element is an optical element.

12. The method as recited in claim 11, wherein the first and the second elements are manufactured from different components.

13. The method as recited in claim 11, wherein at least one of the two elements is sprayed onto a support of the optical device.

14. The method as recited in claim 11, wherein the second element is a mount for the optical element.

15. An optical device, comprising:
a first element made up of at least one first component;
a second element made up of at least one second component; and
a support, at least one of the two elements being situated on the support, at least the first element being an optical element, and at least the first and second components being a plastic material.

16. The device as recited in claim 15, wherein the second element is a mount for the first element.

17. The device as recited in claim 15, wherein the second element is an optical element, the optical element being a light conductor.

18. The device as recited in claim 15, wherein the first element is at least one of an aspherical lens and a diffractive optical element.

19. An image sensor, comprising:
an optical device including a first element made up of at least one first component, a second element made up of at least one second component , and a support, at least one of the two elements being situated on the support, at least the first element being an optical element, and at least the first and second components being a plastic material; and
a light-sensitive chip.

20. A method, comprising:
providing an optical device including a first element made up of at least one first component, a second element made up of at least one second component , and a support, at least one of the two elements being situated on the support, at least the first element being an optical element, and at least the first and second components being a plastic material; and
using the optical device in a motor vehicle.
